(19) United States
(12) Patent Application Publication
(10) Pub. No.: US 2017/0139195 A1
(43) Pub. Date: May 18, 2017

(54) Microscopy Safety Dome

(71) Applicant: Guy Kennedy, Underhill Center, VT (US)

(72) Inventor: Guy Kennedy, Underhill Center, VT (US)

(21) Appl. No.: 15/350,074

(22) Filed: Nov. 13, 2016

Related U.S. Application Data
(60) Provisional application No. 62/255,411, filed on Nov. 14, 2015.

(51) Int. Cl. G02B 21/34; G02B 21/12; G02B 5/20; G02B 21/08

(52) U.S. Cl. CPC G02B 21/34; G02B 21/086; G02B 21/12; G02B 5/20; G02B 21/02

(57) ABSTRACT

A light containment system providing increased safety to microscopy users while allowing the microscopy instrument to be used in an effective and efficient manner is provided. The light containment system includes a hemisphere or dome shaped enclosure that prevents dangerous intensities of light from exiting an objective lens and or microscopy sample holder while still allowing the user to witness and measure the direction of light in three dimensions.

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/255411, entitled “Microscopy Safety Dome”, naming Dr. Guy G. Kennedy as inventor, filed 14 Nov. 2015.

### BACKGROUND

1. Field of Use

The invention relates to microscope slides and more particularly to domed microscope slide covers having optical characteristics.

2. Description of Prior Art (Background)

Development in microscopy has required the incorporation of lasers and other bright light sources for specimen illumination. The power, wavelength, and direction of these lasers and other light sources vary dramatically depending on the application. These sources can range in wavelength from Ultraviolet to the Infrared. Exposure to this light can be hazardous to skin and particularly eyes.

Recently “through the lens” microscopy has very popular. With this technology laser light propagates through the objective lens into the slide sample. On an inverted microscope this means significant potential exposure to the user if the light exits the objective lens in a direction toward the operator. Unfortunately, numerous conditions exist in which the light can exit the objective lens and intrude upon the operator space. Laser light is particularly hazardous for the operator eyes in this situation.

In TIR, Microscopy, the laser alignment is routinely adjusted for clean TIR. When adjusted for pure TIR, the light is directed back into the objective lens from the sample glass water interface, and back into the microscope. Unfortunately, numerous exceptions exist which create conditions in which the light can exit the objective lens and or specimen sample intruding upon the operator space. This laser light creates a hazard particularly for the operator eyes.

For example, conditions in which laser light, can impinge upon the operator include: air bubble in the oil meniscus acting as a lens, redirecting the laser beam; routine adjustments tuning the TIR critical angle; using the laser for “Dirty TIR”; and, using the laser for “Farfield” illumination.

Some commercial laser microscopy systems may have an enclosure to cover the objective lens and or the sample area. These covers may include a safety interlock system to prevent the system for being operated without it in place. The weakness of this design is the inability to see where the laser light is being directed. This makes it necessary to remove or bypass the safety feature in order to make critical adjustments. These adjustments are frequently accomplished while observing the beam impinging upon the local environment such as the walls or ceiling. While doing this at low laser powers may be somewhat risky, higher powers can be very dangerous.

New techniques in imaging have required significantly higher power lasers. These techniques include, but are not exclusive to: STORM Microscopy; PALM Microscopy; Confocal Microscopy; Two Photon Microscopy; and Light Sheet Microscopy. These high power techniques increase the risk of direct laser exposure to the user and others with laser light of high intensity is reflected or refracted from a variety of surfaces.

Concave slides and domed covers are not unknown in the art. For example, U.S. Pat. No. 5,527,510 describes a compliant cover having a degree of concavity chosen to define a volume of regent contained between a cover and a slide. U.S. Pat. No. 3,941,567 includes a hermetic chamber adjacent to a slide. U.S. Pat. No. 3,580,658 describes a gas cooled microscope slide having built-in cooling chambers formed by a through opening in the slide body. U.S. Patent Application 20150153553 describes a fluorescence observation device with a partition dome coupled to a base to define a light shielding chamber with a transparent observation aperture.

Yet, the prior art is silent with regards to a safety slide cover. Thus, there is a need for a cover which allows an operator to see or detect the presence and direction of a laser beam while protecting the operator from exposure to the laser beam.

### BRIEF SUMMARY

The foregoing and other problems are overcome, and other advantages are realized, in accordance with the presently preferred embodiments of these teachings.

In accordance with one embodiment of the present invention a light containment apparatus providing increased safety to microscopy operators while allowing the instrument to be used in an effective and efficient manner is provided. The apparatus includes a hemisphere or of dome shaped enclosure that prevents unwanted or dangerous intensities of light from exiting an objective lens and or microscopy sample holder while still allowing the user to observe the light direction Light sources may include laser light, LED light, Gas Discharge; Tungsten, Mercury Vapor, and/or Mercury Halide.

The invention is also directed towards hemispherical microscopy safety dome comprising a material exhibiting an optical light characteristic such as light transparent, light semi-transparent, light opaque. The dome also includes an inner surface, wherein the inner surface comprises an optical coating.

In accordance with another embodiment of the present invention a microscopy safety dome is provided. The dome includes at least one optical light characteristic, such as, for example, light reflection, light transmission, light absorption, light refraction, wide or narrow band pass filters or blockers; and, may be any suitable shell adaptable to covering a sample receptacle.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of the prior art illustrating the risk to a user without a Microscopy Safety Dome as described herein;

FIG. 2 is a pictorial illustration of one embodiment. of the microscopy safety dome described herein;

FIG. 3 is an operational schematic illustration of the microscopy safety dome in accordance with the invention shown in FIG. 2;

FIG. 4 is an operational schematic illustration of an alternate gas embodiment of the microscopy safety dome in accordance with the invention shown in FIG. 2;

FIG. 5 is an operational schematic illustration of an alternate light scattered embodiment of the microscopy safety dome in accordance with the invention shown in FIG. 2;

FIG. 6 is an operational schematic illustration of an alternate attenuated light scattered or transmitted embodiment of the microscopy safety dome in accordance with the invention shown in FIG. 2;

FIG. 7 is an operational schematic illustration of an alternate thermo-electric embodiment of the microscopy safety dome in accordance with the invention shown in FIG. 2;

FIG. 8 is an operational schematic illustration of an alternate temperature controlled embodiment of the microscopy safety dome in accordance with the invention shown in FIG. 2;

FIG. 9 is an operational schematic illustration of an alternate fluorescent or phosphorescent emission embodiment of the microscopy safety dome in accordance with the invention shown in FIG. 2;

FIG. 10 is an operational schematic illustration of an alternate photo-electric position sensor array embodiment of the microscopy safety dome in accordance with the invention shown in FIG. 2;

FIG. 11 is an operational schematic illustration of an alternate safety interlock embodiment of the microscopy safety dome in accordance with the invention shown in FIG. 2;

FIG. 12 is an operational schematic illustration of an alternate Petrie Dish embodiment of the microscopy safety dome in accordance with the invention shown in FIG. 2;

FIG. 13 is an operational schematic illustration of an alternate integrated Petrie Dish embodiment of the microscopy safety dome in accordance with the invention shown in FIG. 2;

FIG. 14 is an operational schematic illustration of an alternate Petrie Dish embodiment of the microscopy safety dome with selective optical filtering and blocking in accordance with the invention shown in FIG. 2; and

FIG. 15 is an operational schematic illustration of an alternate Petrie Dish embodiment of the microscopy safety dome with an optical window accordance with the invention shown in FIG. 2.

### DETAILED DESCRIPTION

The following brief definition of terms shall apply throughout the application:

The term “comprising” means including but riot limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and maybe included in more than one embodiment of the present invention (importantly, such phrases do not necessarily refer to the same embodiment);

If the specification describes something as “exemplary” or an “example,” it should be understood that refers to a non-exclusive example;

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic

A sample holder or receptacle may be any suitable sample holder or receptacle such as, for example, a sample slide or Petrie Dish; and

Optical light characteristics may include, and not limited to, light scattering, light blocking (specific light wavelengths or multiple light wavelengths), light band pass (wide or narrow band), light filtering (specific light wavelengths or multiple light wavelengths), light absorption (specific light wavelengths or multiple light wavelengths), light transmission (specific light wavelengths or multiple light wavelengths), light refraction (specific light wavelengths or multiple light wavelengths), and/or light reflection (specific light wavelengths or multiple light wavelengths).

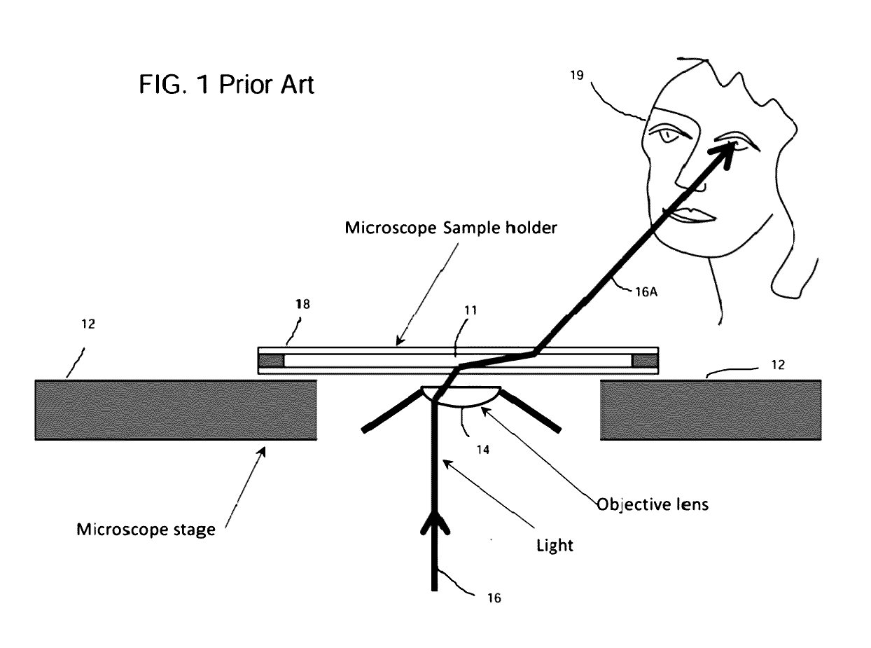

Referring now to FIG. 1 of the drawings, there is shown 1 an illustration of the prior art illustrating the risk to a user without a Microscopy Safety Dome as described herein. Illuminating light 16 travels through objective lens 14 and illuminates sample 11 held by sample holder 18. Sample holder is supported by microscope stage 12. It will be understood that light 16 may include laser light or any other type of light source such as, for example: LED light, Gas Discharge; Tungsten, Mercury Vapor, and/or Mercury Halide generated light. Light 16A is that portion of light 16 which poses a high risk of injury to user 19.

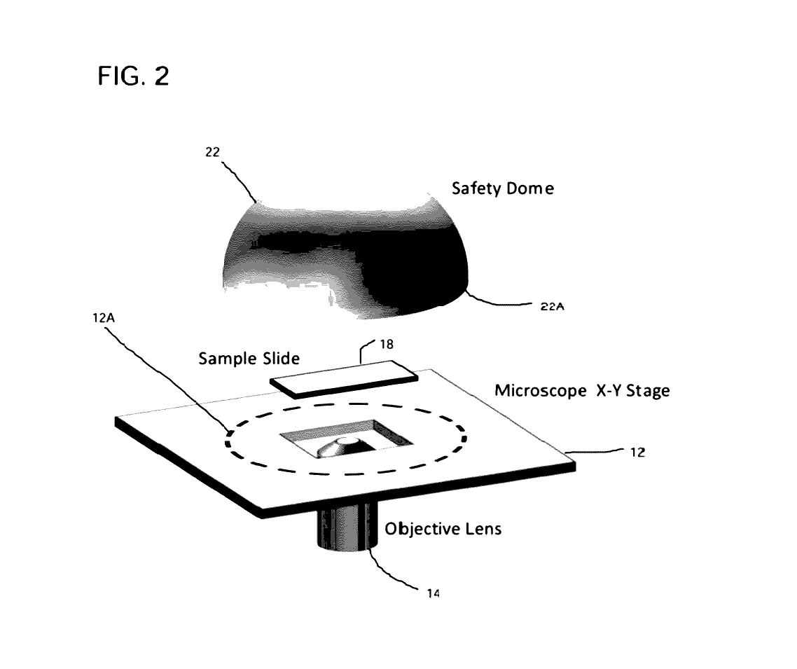

Referring now to FIG. 2 there is shown a pictorial illustration of one embodiment of the microscopy safety dome described herein. Safety dome 22 is adapted to couple to microscope stage 12 and is of sufficient diameter to enclose sample holder 18. Safety dome 22 may be coupled to microscope stage 12 via dome mating surface 22A and stage mating surface 12A. It will be appreciated that any suitable coupling may be used. Suitable coupling may include, for example, magnetic coupling, latch coupling, twist and lock coupling, or weighted coupling.

Still referring to FIG. 2 safety dome 22 may be constructed of any suitable material exhibiting optical characteristics such as fluorescent, phosphorescent opaque and or translucent.

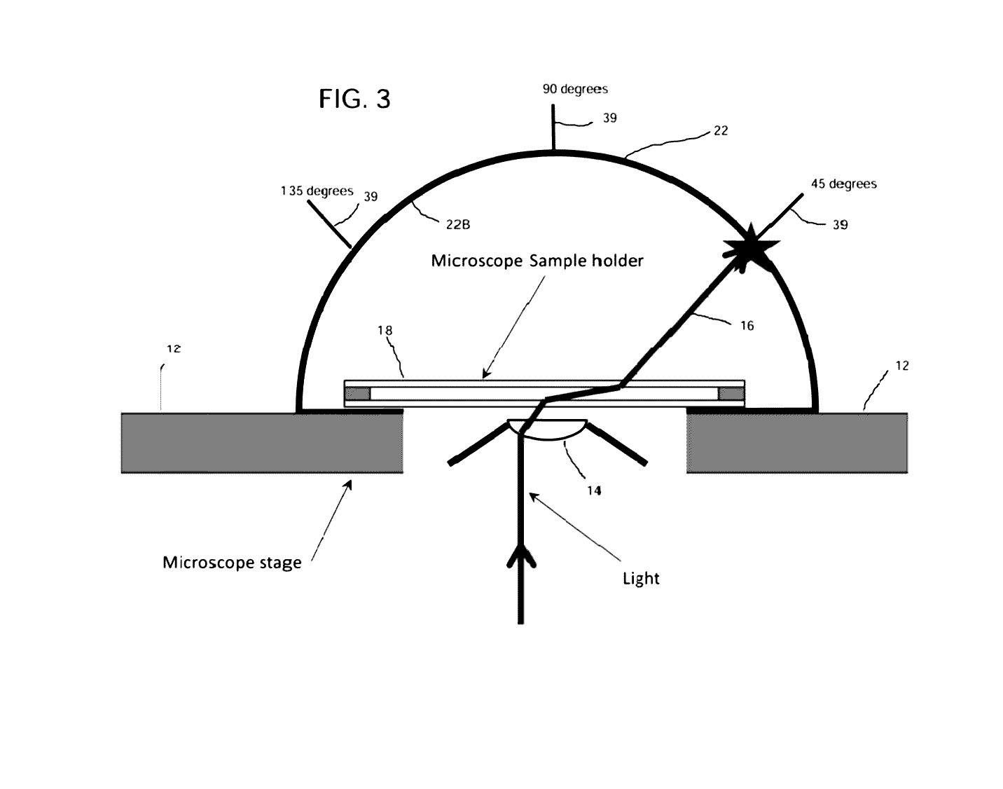

Referring also to FIG. 3 there is shown an operational schematic illustration of the microscopy safety dome or shell in accordance with the invention shown in FIG. 2. In this embodiment safety dome 22 is exhibiting optical blocking, i.e., not letting light 16 pass through the dome 22. Safety dome 22 may be constructed of optical glass, plastic, or metal and may be coated on the interior 22B of dome 22 with desired material to exhibit desired optical characteristics, e.g., blocking, scattering, absorption.

Still referring to FIG. 3 safety dome 22 may include graduated scale markers or rings 39 used to reference light 16 impact angles and quadrants to determine x, y, and z angles of incidence. In addition, dome 22 may incorporate sample slide 18 or be rigidly affixed to sample slide 18 or a sample slide housing to form a one-piece unit. Rigidly affixing the dome 22 to the sample slide 18 or sample slide housing may be any suitable means such as mechanical, e.g., slots, mating tabs, or adhesives.

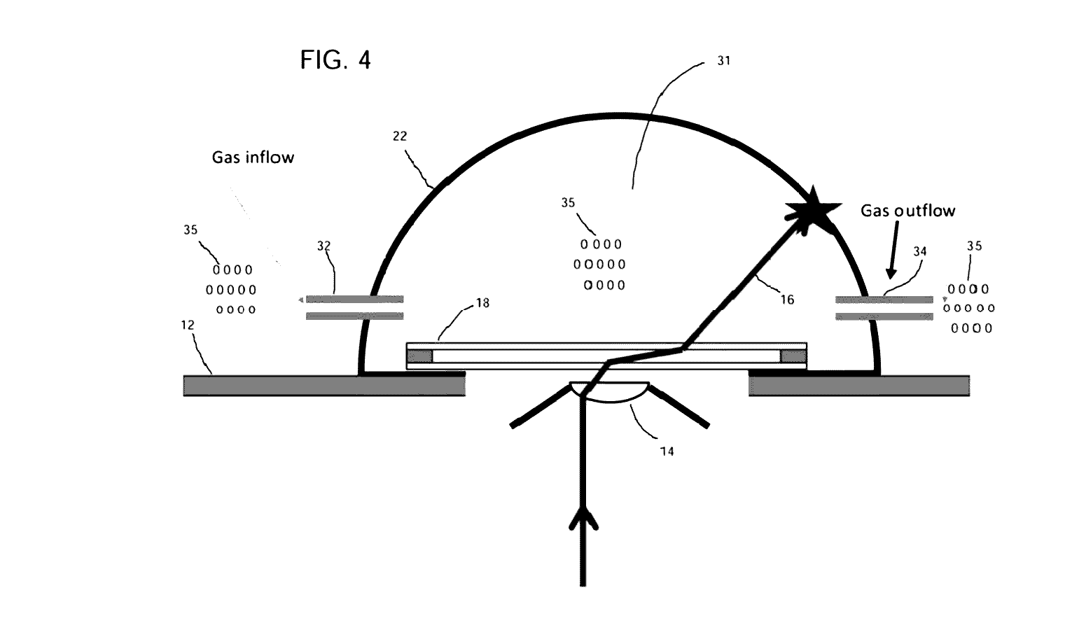

Referring also to FIG. 4 there is shown an operational schematic illustration of an alternate gas embodiment of the microscopy safety dome in accordance with the invention shown in FIG. 2. It will be appreciated that the problems associated with observing heat sensitive specimens, e.g., live specimens are overcome by the present invention through the provision of gas inflow port 32, cooling chamber 31, and gas outflow port 34. A gas 35 is passed continuously through the chamber 31 while the slide 18 is in the microscope (not shown) to cool the slide 18 and thereby prolong the life of a specimen (not shown) while under observation. Gas 35 may be any suitable gas coolant.

Still referring to FIG. 4, it will also be appreciated that gas 35 may be a suitable gas for interacting with light 16 providing a visual marker of the light 16 as it passes through gas 35.

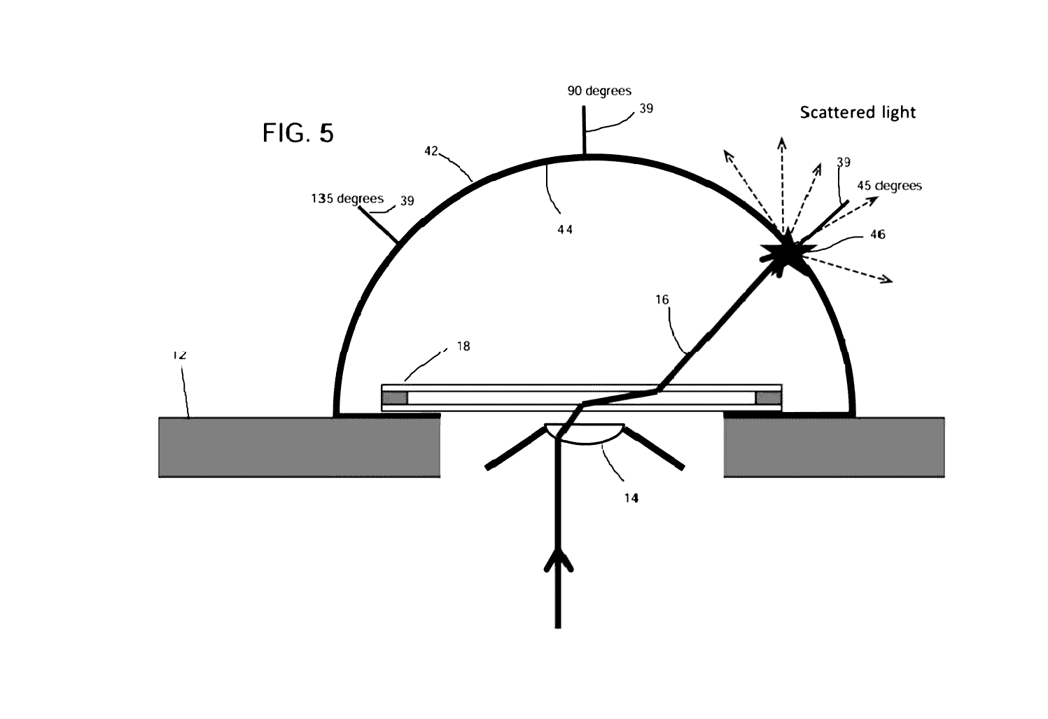

Referring also to FIG. 5, there is shown is an operational schematic illustration of an alternate light scattered embodiment of the microscopy safety dome in accordance with the invention shown in FIG. 2. In this embodiment shell 42 may be any suitable transparent or semi-transparent material such as, for example, optical glass or a clear plastic. In addition, shell 42 may be coated with an optical solution 44 to achieve the desired scattering 46. It will also be appreciated that shell 42 may be an suitable material achieving the desired optical effect, such as, for example, scattering. For example, shell 42 may comprise a glass or plastic shell embedded with light scattering particles, e.g., air bubbles, glass, metal, or plastic spheres or particles. It will also be appreciated that the embedded light scatters may also comprise fluorescent or phosphorescent light characteristics.

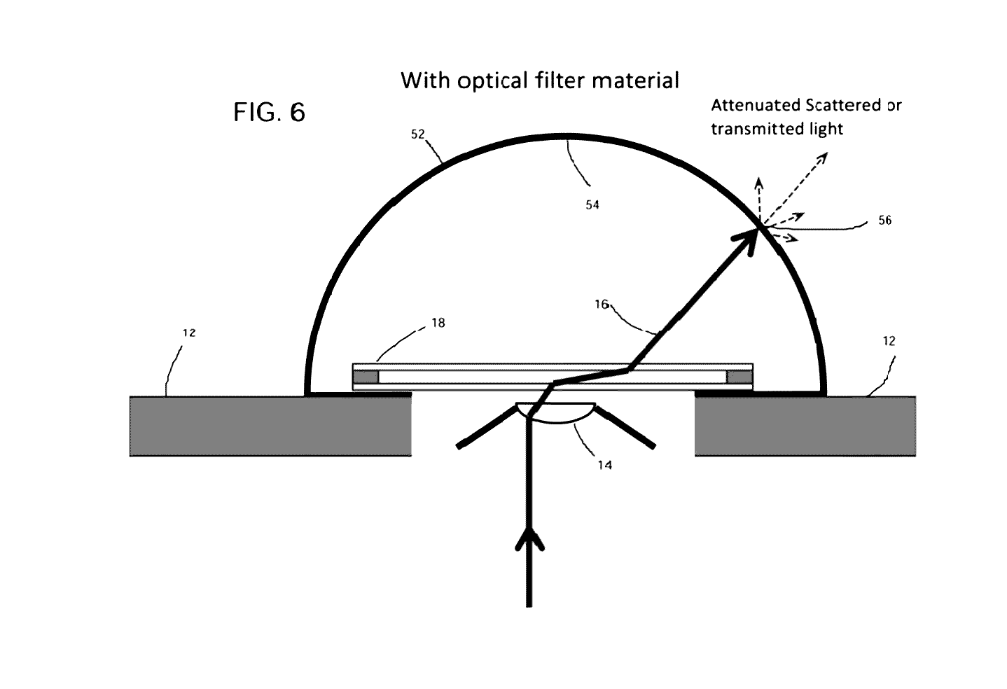

Referring also to FIG. 6 there is shown is an operational schematic illustration of an alternate attenuated light scattered or transmitted embodiment of the microscopy safety dome in accordance with the invention shown in FIG. 2. in this embodiment shell 52 may be any suitable transparent or semi-transparent material such as, for example, optical glass or a clear plastic. In addition shell 52 may be coated with an optical solution 54 to achieve the desired attenuated scattering 56.

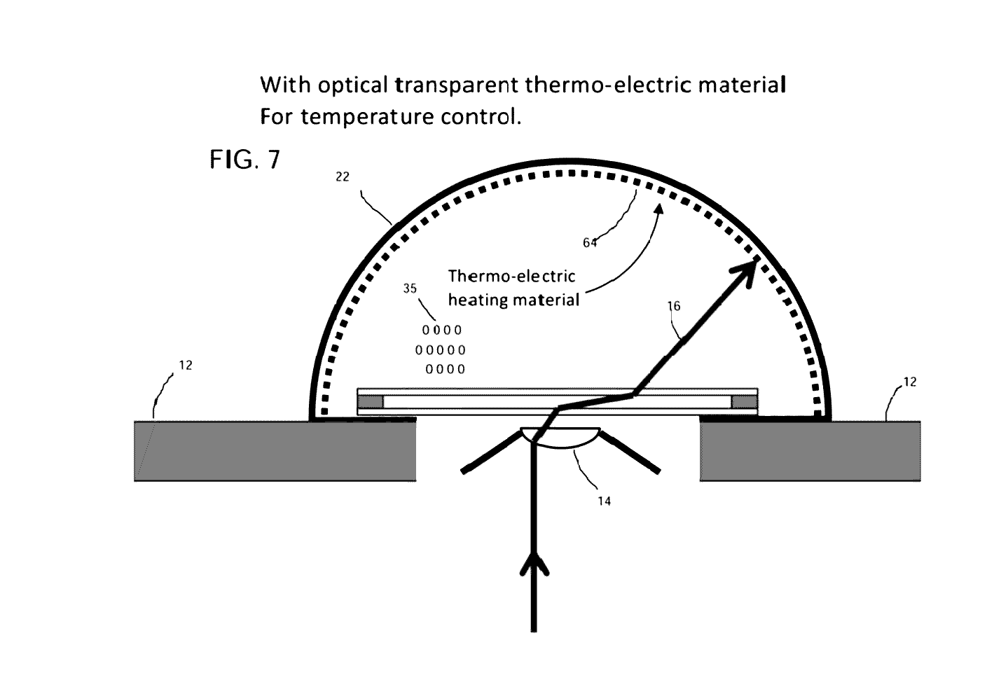

Referring also to FIG. 7 there is shown an operational schematic illustration of an alternate thermo-electric embodiment of the microscopy safety dome in accordance with the invention shown in FIG. 2. In this embodiment shell 22 may be any suitable opaque, transparent or semi-transparent material such as, for example, optical glass or a clear plastic. In addition shell 22 may be coated with a thermo-electric heating material 64 reactive to light 15. Thus, if shell 22 is suitably transparent, as light 16 interacts with heating material 64 a user may visually determine where the light 16 impacts shell 22.

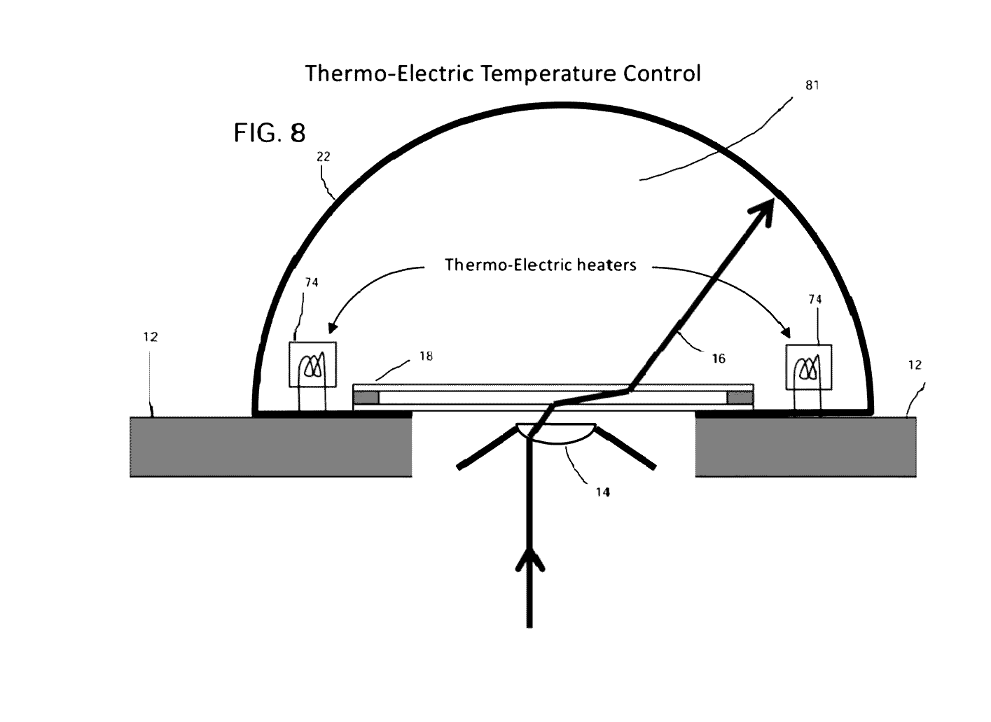

Referring also to FIG. 8 there is shown an operational schematic illustration of an alternate temperature controlled embodiment of the microscopy safety dome in accordance with the invention shown in FIG. 2. Thermo-electric heaters 74 heat the enclosed chamber 81 to a desired temperature to control the optical characteristics (dependent on temperature and humidity) of the gas 35 within chamber 81 and heat dependencies of a sample (not shown) contained within slide 18.

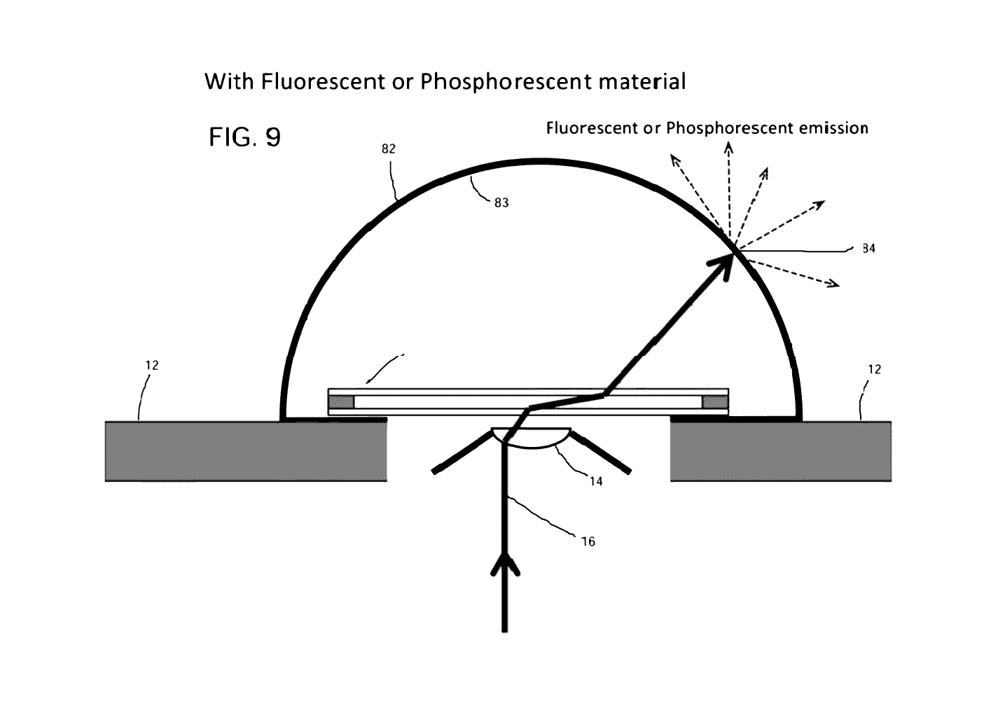

Referring also to FIG. 9 there is shown an operational schematic illustration of an alternate fluorescent or phosphorescent emission embodiment of the microscopy safety dome in accordance with the invention shown in FIG. 2. In this embodiment shell 82 may be any suitable transparent or semi-transparent material such as, for example, optical glass or a clear plastic. In addition shell 82 may be coated with an optical solution 83 to achieve the desired fluorescent or phosphorescent emission 84.

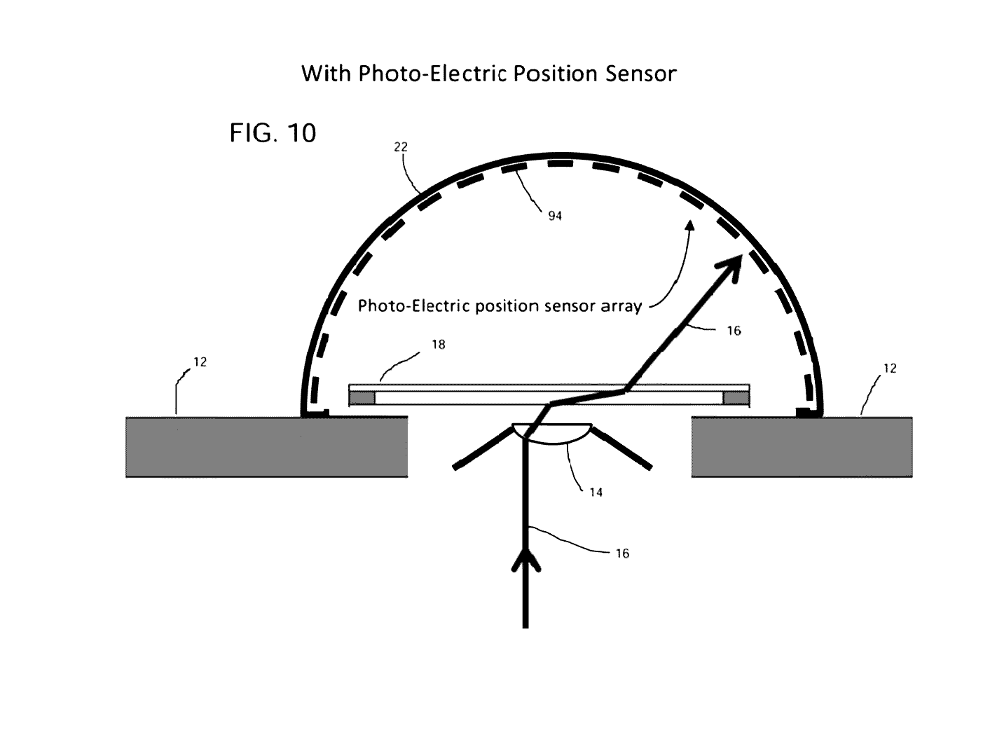

Referring also to FIG. 10 there is shown an operational schematic illustration of an alternate photo-electric position sensor array embodiment of the microscopy safety dome in accordance with the invention shown in FIG. 2. In this embodiment shell 22 may be any suitable opaque, transparent or semi-transparent material such as, for example, optical glass or a clear plastic. In addition shell 22 may be a photo-electric, position sensor array 94 reactive to light 15. Thus, if shell 22 is suitably transparent, as light 16 interacts with photo-electric position sensor array 94 a user may visually determine where the light 16 impacts shell 22.

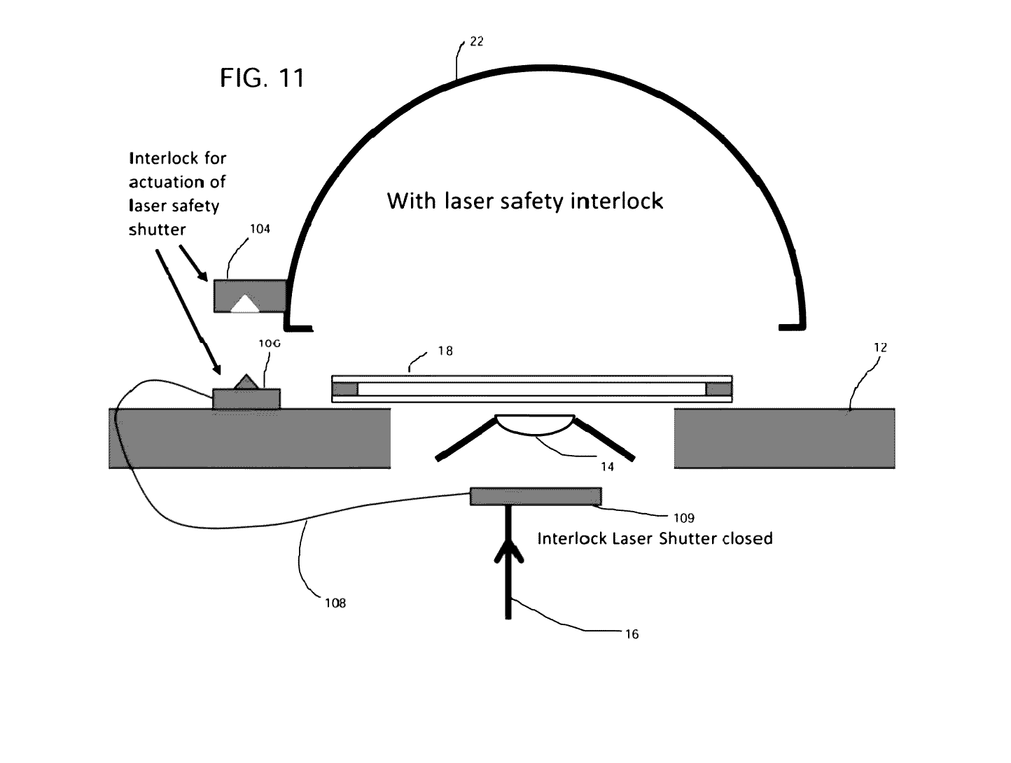

Referring also to FIG. 11 there is shown an operational schematic illustration of an alternate safety interlock embodiment of the microscopy safety dome 22 in accordance with the invention shown in FIG. 2. In this embodiment interlock part 104 attached to the dome 22 must interact with interlock part 106 before interlock shutter 109 opens to allow light 16 to pass through objective 14. Shutter control line 108 senses when interlock pans 104 and 106 are mated or otherwise connected to allow safe operation. It will be understood that shutter control line 108 may be any suitable mechanical, electrical, or wireless control line.

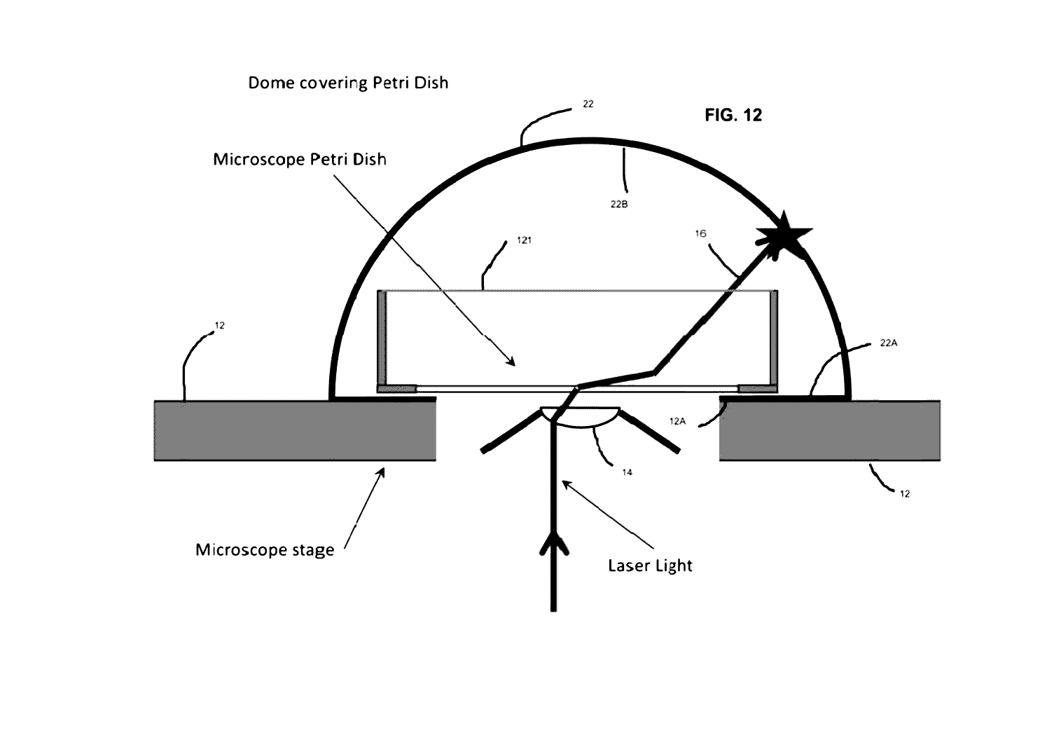

Referring also to FIG. 12 there is shown a pictorial illustration of one embodiment of the microscopy safety dome described herein. Safety dome 22 is adapted to couple to microscope stage 12 and is of sufficient diameter to enclose Petrie Dish 121. Safety dome 22 may be coupled to microscope stage 12 via dome mating surface 22A and stage mating surface 12A. it will be appreciated that any suitable coupling may be used. Suitable coupling may include, for example, magnetic coupling, latch coupling, twist and lock coupling, or weighted coupling.

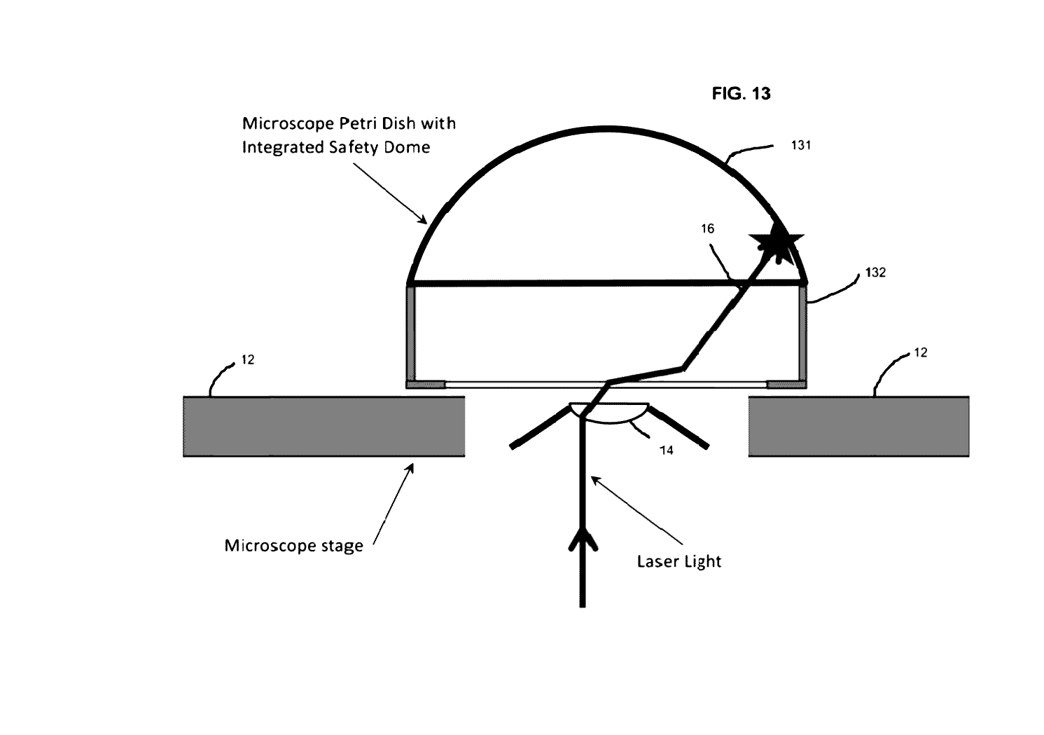

Referring now to FIG. 13 there is shown a pictorial illustration of one embodiment of the microscopy safety dome described herein. Safety dome 131 is adapted to couple to Petrie Dish 132 and is of sufficient diameter to enclose Petrie Dish 131. It will be appreciated that any suitable coupling may be used. Suitable coupling may include, for example, magnetic coupling, latch coupling, twist and lock coupling, or weighted coupling. In addition, the safety dome 131 may be removeable from Petrie Dish 132 or may be permanently affixed to Petrie Dish 132 with suitable adhesives and/or mechanical means.

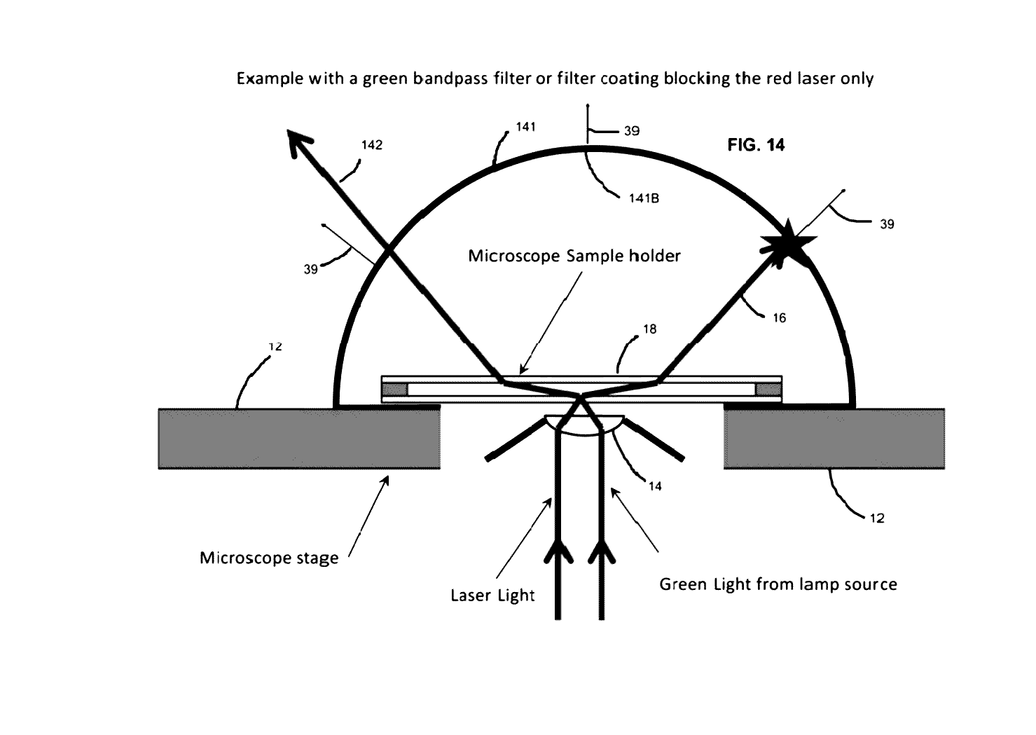

Referring also to FIG. 14 there is shown an operational schematic illustration for an alternate embodiment of the microscopy safety dome or shell in accordance with the invention shown in FIG. 2. In this embodiment safety dome 141 is exhibiting selective optical characteristics. Safety dome 141 may include material such as optical glass, plastic, or metal and may be coated on the interior 141B of dome 141 with desired material coating to exhibit desired optical characteristics. Selective optical characteristics employed by safety dome 141 may include wavelength band pass, wavelength band blocking, narrow wavelength band pass or blocking and/or wide wavelength band pass or blocking. For example, FIG. 14 shows safety dome 141 allowing light from lamp source 142 to pass through safety dome 141 while blocking laser light 16. It will be appreciated that the selective optical characteristics may be a feature of the safety dome 141 material and/or a feature of the material coating on interior 141B.

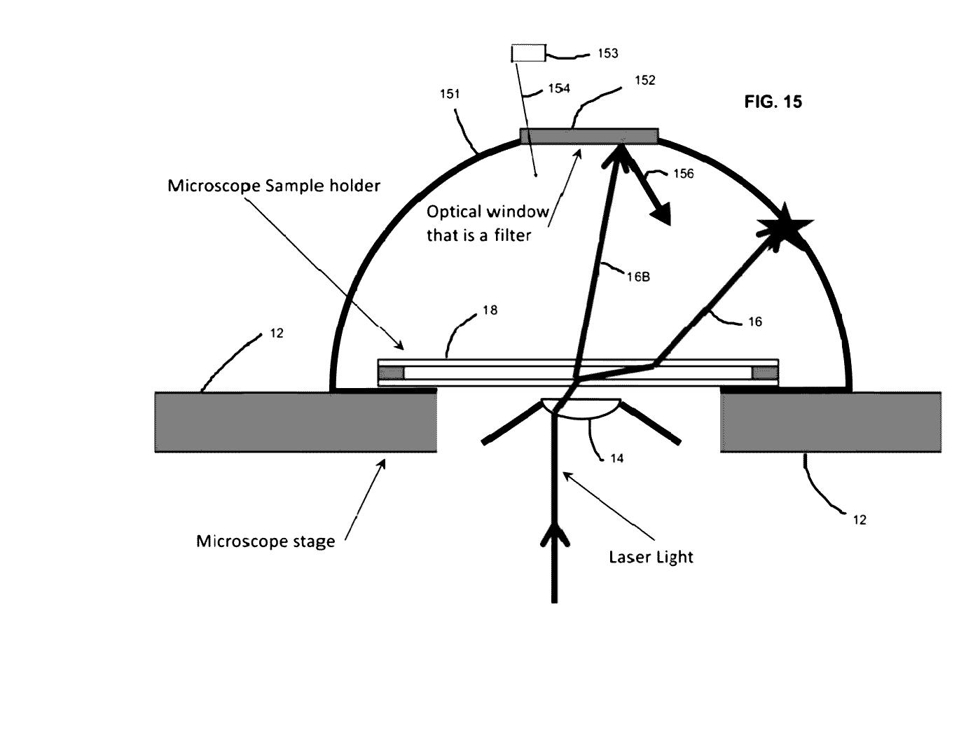

Referring also to FIG. 15 there is shown an operational schematic illustration for an alternate embodiment of the microscopy safety dome 151 or shell in accordance with the invention shown in FIG. 2. In this embodiment safety dome 151 incorporates a laser blocking filter 152 allowing band pass for light of other wavelengths to enter into the dome from outside allowing brightfield illumination 154 from a brightfield light source 153. The filter 152 may be absorptive to laser light 16B and/or may be reflective to laser light 16B as illustrated by reflected laser light 156.

It should be understood that the foregoing description is only illustrative of the invention. Thus, various alternatives and modifications can be devised by those skilled in the art without departing from the invention. For example, the interlock feature shown in FIG. 11 can be combined, with any of the other features shown in FIG. 2 through FIG. 15. In addition, materials used for shells e.g., 22 in FIG. 2) may be fluorescent, phosphorescent opaque and or translucent. The invention described herein may be incorporated to microscope design, or as an aftermarket kit or accessory. It will be appreciated that with diffusive, and or translucent material as described herein, a user can directly witness the location and size of a light beam (e.g., 16 in FIG. 2) exiting the sample area (e.g., slide 18 in FIG. 2). Materials for shell (e.g., 22 in FIG. 2) include construction containing or fabricated from: list of plastics, ceramics, glass, silica, silicone, fluorescent dye, lanthanides, quantum dots, evaporated optical coatings, spray coatings, light absorbing, coatings, optical fiber, optical waveguide, The size may varied from just big enough to block the light above the sample, to as large as the microscope can physically accommodate. Accordingly, the present invention is intended to embrace all such alternatives, modifications and variances that fall within the scope of the appended claims.

What is claimed is:

1. A microscopy safety dome comprising:
a hemispherical shell, wherein the hemispherical shell comprises:
a material exhibiting an optical light characteristic selected from the group of light transparent, light semi-transparent, and light opaque; and
an inner surface, wherein the inner surface comprises an optical coating.

2. The microscopy safety dome as in claim 1 wherein the hemispherical shell comprises:
a material exhibiting an optical light characteristic selected from the group of light transparent and light semi-transparent; and
wherein the material comprises an optical light characteristic.

3. The microscopy safety dome as in claim 2 further comprising reference marks for determining x, and z angles of incidence of tight impacting the hemispherical shell.

4. The microscopy safety dome as in claim 1 further comprising:
a gas inflow port; and
a gas outflow port.

5. The microscopy safety dome as in claim 1 further comprising a thermo-electric heating material.

6. The microscopy safety dome as in claim 1 further comprising at least one thermo-electric heater.

7. The microscopy safety dome as in claim 1 further comprising a photo-electric position sensor array.

8. The microscopy safety dome as in claim 1 further comprising a laser safety interlock.

9. The microscopy safety dome as in claim 1 further comprising a thermo-electric heating material.

10. The microscopy safety dome as in claim 1 further comprising the microscopy safety dome incorporating a sample receptacle to form a one-piece unit.

11. The microscopy safety dome as in claim 10 wherein the sample receptacle comprises a sample slide.

12. The microscopy safety dome as in claim 10 wherein the sample receptacle comprises a Petrie Dish.

13. The microscopy safety dome as in claim 1 further comprising an optical window.

14. A microscopy safety dome comprising:
a hemispherical shell; and
an inner surface, wherein the inner surface comprises an optical coating.

15. The microscopy safety dome as in claim 14 further comprising the microscopy safety dome incorporating a sample receptacle to form a one-piece unit.

16. The microscopy safety dome as in claim 15 wherein the sample receptacle comprises a sample slide.

17. The microscopy safety dome as in claim 15 wherein the sample receptacle comprises a Petrie Dish.

18. A microscopy safety dome comprising:
a shell adaptable to covering a sample receptacle; and
wherein the shell comprises at least one optical light characteristic.

19. The microscopy safety dome as in claim 18 wherein the shell further comprises an inner surface, wherein the inner surface comprises an optical coating.

20. The microscopy safety dome as in claim 18 further comprising a sample receptacle.
